(19) United States
(12) Patent Application Publication
(10) Pub. No.: US 2007/0289489 A1
(43) Pub. Date: Dec. 20, 2007

(54) WATER-PROOFING COMPOSITION

(76) Inventors: Herbert L. Wissel, Indianapolis, IN (US); Joe Brandenburg, Carleton, MI (US); Bucky Brooks, Monroe, MI (US)

Correspondence Address: BUTZEL LONG, 350 SOUTH MAIN STREET, SUITE 300, ANN ARBOR, MI, 48104, US

(21) Appl. No.: 11/756,728

(22) Filed: Jun. 1, 2007

Related U.S. Application Data
(60) Provisional application No. 60/809,965, filed on Jun. 1, 2006.

(51) Int. Cl. C08L 95/00

(52) U.S. Cl. 106/277; 106/281.1; 524/59

(57) ABSTRACT

A water-proofing composition which includes an emulsified asphalt component plus a latex blend with calcium chloride as a breaking solution. The water-proofing composition becomes tack-free quickly after application and can be applied to asphalt, concrete, brick, stone, wood, metal, wood, various primed metals and other substrates surfaces. The water-proofing composition is applied to a desired substrate surface by a co-depositing the emulsified asphalt component plus a latex blend with calcium chloride separately so that they mix together during the application process.

### RELATED APPLICATION

The present application is based upon U.S. Provisional Patent Application Ser. No. 60/809,965, filed Jun. 1, 2006 and claims priority thereto under 35 U.S.C. §120.

### TECHNICAL FIELD

The present invention relates to compositions and methods useful for water-proofing or damp-proofing various water-penetrable materials used in building construction and other civil engineering projects, including roofing applications, erosion control, leachate ponds, bridge decks, etc. More specifically, the present invention relates to a two component water-proofing composition that can be applied to a surface or substrate at any desired thickness.

### BACKGROUND ART

Various materials used in building construction and other civil engineering projects such as roads, bridges and landfills are susceptible to water penetration resulting either from their inherent properties or imperfections such as cracks or pores. Reducing or eliminating water penetration through structures formed of these materials often is desirable, and may be critical in certain structures such as those housing expensive electrical equipment or tunnels moving vehicular or pedestrian traffic under bodies of water. Available water-proofing agents include coal tar-based and asphalt-based compositions. Asphalt-based compositions in the form of single or multilayer sheets of water-proofing and asphalt-based adhesives are known. Bituthene® is a brand name of water-proofing membranes that are commercially available asphalt-based water-proofing agents.

Many currently available water-proofing agents are very effective when applied correctly. Correct application of currently available materials, however, requires that the structure be dry before the water-proofing agent is applied. Although water-proofing agents have been used for many years, for the most part water-proofing wet structures remains a difficult application. Thus, inclement weather and the time required for curing of hydrophilic construction materials such as concrete result in delays which increase construction costs. Therefore, there has been and remains a need for compositions and methods which enable application of water-proofing agents to dry, wet, or incompletely cured construction materials.

Another application of water-proofing materials is in the roofing industry. For almost a century bituminous roofing membranes have been used in the United States to protect buildings, their contents and the occupants from the weather. The most common type of bituminous roofing membranes consist of two to five layers of felt or fabric which during application to the roof are made to adhere together with bituminous material, such as tar, pitch or asphalt. The fabrics or felts may contain organic material, asbestos or glass. In general, these types of roofing membrane have been the source of problems for manufacturers of the membrane, roof designers, appliers and users.

Typically roofing membranes and hot asphalt or tar are used in alternate layers or base membranes are mopped in with asphalt or tar. A protective layer of gravel or crushed slate or the like may be applied to the top of the upper bituminous layer to improve the weathering properties of the roofing and to change the color of the roofing from the black color of asphalt.

The present invention provides a water-proofing composition that can be applied to a variety of structures and surfaces, including building construction, roofing applications and various civil engineering projects.

### DISCLOSURE OF THE INVENTION

According to various features, characteristics and embodiments of the present invention which will become apparent as the description thereof proceeds, the present invention provides a water-proofing composition that includes:

about 70-95 wt. % of an emulsified asphalt component;

about 10-35 wt. % of a latex blend; and

about 10-15 wt. % calcium chloride.

The present invention further provides a water-proof structure which comprises a substrate having applied thereto a coating of a water-proofing composition that includes:

a first component that comprises:
about 70-95 wt. % of an emulsified asphalt component and
about 10-35 wt. % of a latex blend; and

a second component that comprises about 10-15 wt. % calcium chloride.

The present invention also provides a method of water-proofing a structure which involves:

applying a water-proofing composition to a surface of a structure which water-proofing composition comprises:

a first component that comprises:
about 70-95 wt. % of an emulsified asphalt component and
about 10-35 wt. % of a latex blend; and

a second component that comprises about 10-15 wt. % calcium chloride.

The present invention further provides a water-proof layer which comprises the co-mixed produce of about 70-95 wt. % of an emulsified asphalt component, about 10-35 wt. % of a latex blend and about 10-15 wt. % calcium chloride.

### BEST MODE FOR CARRYING OUT THE INVENTION

The present invention is directed to a two component water-proofing composition that can be applied to a surface or substrate at any desired thickness.

The water-proofing composition of the present invention has also been formulated so that once applied it quickly loses its tackiness so that little or no appreciable pick-up of the composition occurs. In general, the composition is substantially tack-free to pick-up after application. This ability to quickly lose any tackiness solves constructability issues that plague other approaches to water-proofing compositions.

The water-proofing composition of the present invention is applied as a dual component system that can be applied by co-spraying the two components together. One of the components is an emulsified asphalt composition containing a latex blend and the other component is a calcium chloride (CaCl₂).

The emulsified asphalt component includes an asphalt component, water and a surfactant component that reduces the surface tension at the interface of the suspended asphalt particles.

According to one embodiment of the present invention tall oil, which is a mixture of, fatty acids and other materials is used as the fatty acid component. In addition, sodium hydroxide is added for pH control, as necessary, to stabilize the emulsion.

The emulsion blend includes a latex component, a cross-linking agent and an adhesion promoter.

According to one embodiment of the present invention the elastomer component is neoprene which has a high flame resistance and therefore imparts a high fire rating to the overall water-proofing composition. Zinc oxide is used as the cross-linking agent and also provided a uniform color to the finished product. The adhesion promoter is added to improve adhesion to different surfaces. In addition, the adhesion promoter was found to provide a more uniform break in the emulsion when it is atomized during application. An adhesion promoter is used to improve adhesion of the water-proofing composition so that it could be satisfactorily applied to concrete, brick, stone, wood, various metals, various primed metals and other substrates. According to the present invention it is possible to build up the thickness of the water-proofing composition to any desired thickness during the application process.

According to one embodiment of the present invention, the emulsified asphalt component includes about 40-60 wt. % asphalt, about 10-20 wt. % latex, about 30-50 wt. % water, about 0.2-2 wt. % tall oil and about 0.1-1.0 wt. % sodium hydroxide (NaOH).

Further, the latex blend includes about 10-30 wt. % neoprene, about 2-6 wt. % zinc oxide and about 0.5-3 wt. % of an adhesion promoter such as Pave Bond 192 (commercially available from Rohn Hass, Andover, Mass.) and/or any other amine adhesion promoter and a balance of water. Additional examples of adhesion promoters are exemplified by those including the Wetfix and Kling Beta series of adhesion promoters from Akzo Nobel, the Adher series of adhesion promoters available from Arr-Maz Products, Idulin CBA-4 and Indulin 814 from Mead Westvaco as well as the Pave Bond series of adhesion promoters from Rohm & Hass, and any other amine based adhesion promoter.

In use, the first component is about 70-95 wt. % and more preferably about 71-85 wt. % of the emulsified asphalt component is blended with about 10-35 wt. % and more preferably about 12-20 wt. % of the latex blend and combined with the second component being about 10-15 wt. % calcium chloride (CaCl₂). The two components are co-applied together using a spraying technique in which each component was sprayed from a separate spraying device so that the two components mix together as their respective spray streams intersected and became blended.

For water-proofing a surface or substrate, it needs to be substantially clean and mostly free from moisture. As discussed above, the dual component composition is applied to a surface or substrate by a co-spraying technique in which the separately spayed components become mixed together as they are laid down on a surface or substrate. If desired, it is possible to further add/mix known filler or strengthening materials into the applied coating, such as resin or glass fibers which can help build up the coating to a desired thickness and/or impart structural strength to the coating. It is further within the scope of the present invention to apply the water-proofing composition together with various conventional membrane layers for roofing applications, although it is not necessary to include such membranes to provide for water-proofing.

The joint sealing composition of the present invention has been found to have excellent adhesion characteristics which allow it to seal an asphalt layer to virtually any underlying substrate, including asphalt, concrete, brick, stone, wood, various primed metals and other substrates, or against such substrates. In addition, since the joint sealing composition includes moisture, it can be applied to damp or moist surfaces and substrates.

Although the present invention has been described with reference to particular means, materials and embodiments, from the foregoing description, one skilled in the art can easily ascertain the essential characteristics of the present invention and various changes and modifications can be made to adapt the various uses and characteristics without departing from the spirit and scope of the present invention as described above or set forth in the attached claims.

1: A water-proofing composition that comprises:
a first component that comprises:
about 70-95 wt. % of an emulsified asphalt component, and
about 10-35 wt. % of a latex blend; and
a second component that comprises about 10-15 wt. % calcium chloride.

2: A water-proofing composition according to claim 1, wherein the first component comprises about 40-60 wt. % asphalt, about 10-20 wt. % latex, about 30-50 wt. % water, about 0.2-2 wt. % tall oil and about 0.1-1.0 wt. % sodium hydroxide.

3: A water-proofing composition according to claim 1, wherein the latex blend comprises about 10-30 wt. % neoprene, about 2-6 wt. % zinc oxide and about 0.5-3 wt. % of an adhesion promoter, with the adhesion promoter added by weight of the latex blend.

4: A water-proofing composition according to claim 2, wherein the latex blend comprises about 10-30 wt. % neoprene, about 2-6 wt. % zinc oxide and about 0.5-3 wt. % of an adhesion promoter, with the adhesion promoter added by weight of the latex blend.

5: A water-proof structure which comprises a substrate having applied thereto a coating of a water-proofing composition that comprises:
a first component that includes:
about 70-95 wt. % of an emulsified asphalt component and
about 10-35 wt. % of a latex blend; and
a second component that comprises about 10-15 wt. % calcium chloride.

6: A water-proof structure according to claim 5, wherein the substrate comprises at least one of asphalt, concrete, brick, stone, wood, metal, and various primed metals and other substrates.

7: A water-proof structure according to claim 5, wherein the first component comprises about 40-60 wt. % asphalt, about 10-20 wt. % latex, about 30-50 wt. % water, about 0.2-2 wt. % tall oil and about 0.1-1.0 wt. % sodium hydroxide.

8: A water-proof structure according to claim 5, wherein the latex blend comprises about 10-30 wt. % neoprene, about 2-6 wt. % zinc oxide and about 0.5-3 wt. % of an adhesion promoter, with the adhesion promoter added by weight of the latex blend.

9: A water-proof structure according to claim 7, wherein the latex blend comprises about 10-30 wt. % neoprene, about 2-6 wt. % zinc oxide and about 0.5-3 wt. % of an adhesion promoter, with the adhesion promoter added by weight of the latex blend.

10: A method of water-proofing a structure which comprises:
applying a water-proofing composition to a surface of a structure which water-proofing composition comprises:
a first component that includes:
about 70-95 wt. % of an emulsified asphalt component and
about 10-35 wt. % of a latex blend; and
a second component that comprises about 10-15 wt. % calcium chloride.

11. A method of water-proofing a structure according to claim 10, wherein the first component and second component are co-applied to the surface simultaneously.

12: A method of water-proofing a structure according to claim 11, wherein the first component and second component are co-sprayed onto the surface.

13: A method of water-proofing a structure according to claim 10, wherein the structure comprises at least one of asphalt, concrete, brick, stone, wood, metals, various primed metals and other substrates.

14: A method of water-proofing a structure according to claim 10, wherein the water-proofing composition is substantially tack-free to pick-up after being applied to the surface.

15: A method of water-proofing a structure according to claim 10, wherein the emulsified asphalt component comprises about 40-60 wt. % asphalt, about 10-20 wt. % latex, about 30-50 wt. % water, about 0.2-2 wt. % tall oil and about 0.1-1.0 wt. % sodium hydroxide.

16: A method of water-proofing a structure according to claim 10, wherein the latex blend comprises about 10-30 wt. % neoprene, about 2-6 wt. % zinc oxide and about 0.5-3 wt. % of an adhesion promoter, with the adhesion promoter added by weight of the latex blend.

17: A method of water-proofing a structure according to claim 15, wherein the latex blend comprises about 10-30 wt. % neoprene, about 2-6 wt. % zinc oxide and about 0.5-3 wt. % of an adhesion promoter, with the adhesion promoter added by weight of the latex blend.

18: A water-proof layer which comprises the co-mixed produce of a first component that comprises about 70-95 wt. % of an emulsified asphalt component and about 10-35 wt. % of a latex blend, and a second component that comprises about 10-15 wt. % calcium chloride.

19: A water-proof layer according to claim 18, wherein the first component comprises about 40-60 wt. % asphalt, about 10-20 wt. % latex, about 30-50 wt. % water, about 0.2-2 wt. % tall oil and about 0.1-1.0 wt. % sodium hydroxide.

20: A water-proof layer according to claim 19, wherein the latex blend comprises about 10-30 wt. % neoprene, about 2-6 wt. % zinc oxide and about 0.5-3 wt. % of an adhesion promoter, with the adhesion promoter added by weight of the latex blend.
